(19) United States
(12) Patent Application Publication
(10) Pub. No.: US 2020/0106843 A1
(43) Pub. Date: Apr. 2, 2020

(54) METHOD AND SYSTEM OF AUTOMATING CONTEXT-BASED SWITCHING BETWEEN USER ACTIVITIES

(71) Applicant: WIPRO LIMITED, BANGALORE (IN)

(72) Inventors: Gopichand Agnihotram, Bangalore (IN); Ghulam Mohiuddin Khan, Bangalore (IN); Suyog Trivedi, Indore (IN)

(21) Appl. No.: 16/202,124

(22) Filed: Nov. 28, 2018

(30) Foreign Application Priority Data
Sep. 27, 2018 (IN) 201841036573

(51) Int. Cl. H04L 29/08; G06F 16/9035

(52) U.S. Cl. CPC H04L 67/22; G06F 16/9035; H04L 67/12

(57) ABSTRACT

Disclosed herein is a method and system for automating context-based switching between user activities. The method comprises receiving user inputs from users in one or more input modes and based on a predefined score associated with input modes the context of user input is determined. Based on the determined context and one or more predefined activities of users, a predefined first activity is recommended. Further, a deviation from the context associated with the predefined first activity to a context associated with a second activity is detected, based on user input. Since the context is deviated, the second activity is performed upon detecting availability of pre-recorded activities related to second activity. Once the second activity is completed, system switches back to predefined first activity to complete predefined first activity. The system understands context of the user based on user inputs and performs different activities according to users comfort and requirements.

### TECHNICAL FIELD

The present subject matter is generally related to artificial intelligence based human-machine interaction systems and more particularly, but not exclusively, to method and system for automating context-based switching between user activities.

### BACKGROUND

With advancement in computer technology, various user activities or processes such as scheduling appointments, booking movie tickets, flight bookings, online shopping and the like has been automated. To initiate the automated activity or the process, humans interact with computers in many ways. One such way is through Graphical User Interface (GUI) for providing user inputs. GUI is a visual way of interacting with the computer using items such as windows, icons, and menus. Another way is text-based interaction. Text based applications typically run faster than software involving graphics as the machine does not spend resources on processing the graphics, which generally requires more system resources than for the text. Hence for the same reason, text-based applications use memory more efficiently. Voice User Interface (VUI) is another way of interaction of human with computers. V UI human interaction is possible through a voice or speech platform. Humans can also interact with computers using gestures.

The existing techniques only combine some of these interacting modes such as voice, text, GUI, gestures and the like for human computer interaction but do not provide better quality in terms of interpreting correct input while interaction of humans with computer. Hence, the analysis of the input may not be accurate and may lead to providing irrelevant responses for the user input. Further, while the activity or process is automated, there might arise a situation where the context is changed and the user is trying to perform another process. The existing techniques fails to identify the change in context based on the user inputs and fails to switch between user activities automatically.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein is a method of automating context-based switching between user activities. The method comprises receiving, by an activity automation system, user input in one or more input modes from one or more users. The method comprises determining a context of the user input based on a predefined score associated with each of the one or more input modes. The method comprises recommending a pre-defined first activity for the one or more users based on the context and pre-recorded activities of the one or more users stored in a database associated with the activity automation system. Further, the method comprises detecting a deviation from the context associated with the predefined first activity to a context associated with a second activity based on the user input. Since there is a deviation in the context, the method proceeds to performing the second activity upon detecting availability of pre-recorded activities related to the second activity in the database. Once the second activity is concluded, the method switches to the predefined first activity for completing the predefined first activity.

Further, the present disclosure discloses an activity automation system for automating context-based switching between user activities. The activity automation system comprises a processor and a memory communicatively coupled to the processor, wherein the memory stores the processor-executable instructions, which, on execution, causes the processor to receive user input in one or more input modes from one or more users. Further, the processor determines context of the user input based on a predefined score associated with each of the one or more input modes. Thereafter, the processor recommends a predefined first activity for the one or more users based on the determined context and pre-recorded activities of the one or more users stored in a database associated with the activity automation system. Thereafter, the processor detects a deviation from the context associated with the predefined first activity to a context associated with a second activity based on user input. Further, the processor performs a second activity based on the deviated context upon defecting availability of pre-recorded activities related to the second activity in the database. Once the second activity is completed, the processor switches to the predefined first activity to complete the predefined first activity.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an exemplary environment for automating context-based switching between user activities in accordance with some embodiments of the present disclosure;

FIG. 2 shows block diagram of an activity automation system in accordance with some embodiments of the present disclosure;

FIG. 3 shows a flowchart illustrating method of automating context-based switching between user activities in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, “including” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to method and system for automating context-based switching between user activities. The system receives user inputs from one or more users in one or more input modes such as voice, text, video and gesture. The system determines a context of the user input based on a predefined score associated with each of the one or more input modes. The predefined score is assigned to each input mode during training phase of the system. Based on the determined context and one or more predefined activities of the one or more users which are stored in a database associated with the system, the system recommends a predefined first activity for the one or more users. While the predefined first activity is being performed, the system may detect deviation from the context associated with the predefined first activity to a context associated with a second activity, based on the user input. Since the context is deviated, the system performs the second activity if pre-recorded activities related to the second activity is available in the database. Once the second activity is completed, the system switches back to the predefined first activity to complete the predefined first activity. In this manner, the system understands the context of the user based on user inputs and performs different activities according to user comfort and requirements.

In the following detailed description of the embodiments of the disclosure, reference is made to the accompanying drawings that form a part hereof, and in which are shown by way of illustration of embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

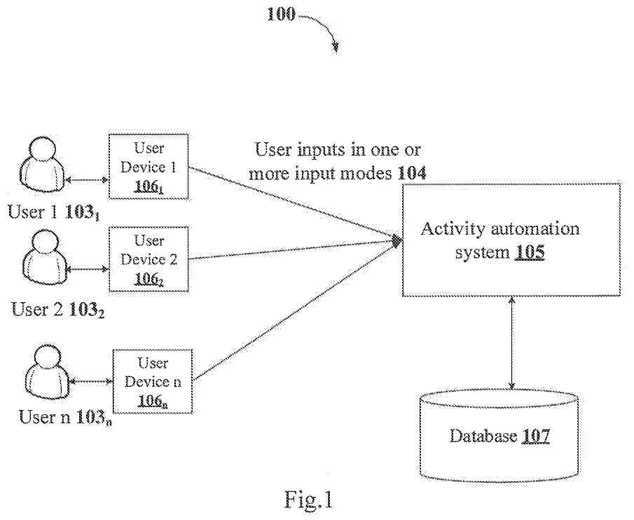

FIG. 1 shows an exemplary environment 100 for automating context-based switching between user activities in accordance with some embodiments of the present disclosure. The environment 100 includes user 1 103₁ to user n 103ₙ (collectively referred as one or more users 103), user device 1 106₁ to user device n 106ₙ (collectively referred as one or more user devices 106) associated with corresponding one or more users 103, an activity automation system 105 and a database 107. The one or more users may provide user inputs in one or more input modes (also alternatively referred as user inputs) 104 to the activity automation system 105 for automating an activity or a process. The one or more users 103 may use the corresponding user devices 106 such mobile phone, a computer, tablet and the like to provide the user inputs in the one or more input modes 104. In an embodiment, there may be group of users working towards a common objective. In this scenario, each of the one or more users 103 may provide the user input in one or more input modes 104 to the activity automation system 105. The activity or the process may include, but not limited to, booking a flight ticket, booking a movie ticket, scheduling an appointment and the like. The one or more input modes may include, but not limited to, voice, text, video or gesture. In an embodiment, the activity automation system 105 is trained for the one or more users and group of users and during the training phase each of the one or more input modes used by each of the one or more users is assigned with a predefined score. As an example, for user-1, the input mode “voice” may be assigned with a predefined score of 10. The input mode “text” may be assigned with a predefined score 30, the input mode “video” may be assigned with a predefined score 20 and the input mode “gesture” may be assigned with a predefined score “40”. The input mode “gesture” may be assigned with a high score based on previous activities of the user wherein using gesture as the input, there were more relevant responses provided to the user-1. Upon receiving the user input in the one or more input modes and based on the predefined score associated with each of the one or more input modes, the activity automation system 105 determines context of the user input.

In an embodiment, based on the determined context and one or more pre-recorded activities of the one or more users, the activity automation system 105 recommends a predefined first activity for the user. The pre-recorded activities of each of the one or more users is stored in the database 107. The pre-recorded activities may be step-by-step process or tasks for performing an activity. As an example, the predefined first activity recommended by the activity automation system 105 for user-1 may be “booking flight tickets”. The predefined activity “booking flight tickets” may include set of actions or tasks for booking the flight tickets. While performing the predefined first activity of“booking flight tickets”, the activity automation system 105 may detect the deviation in the context based on the user inputs 104 captured while performing the predefined first activity. The user may involve in a conversation while booking the flight tickets and during the conversation, the user may wish to book a movie ticket. Therefore, the activity automation system 105 detects that the user is trying to book a movie ticket based on the user inputs 104 captured through input mode “text” or “gesture”. Since there is a deviation in the context, the activity automation system 105 detects availability of the pre-recorded activities for the second activity in the database 107. If the pre-recorded activities are available, the activity automation system 105 performs second activity of “booking movie ticket”. The second activity “booking movie ticket” may include set of actions or tasks for booking the movie ticket. Once the second activity is completed, the activity automation system 105 switches back to performing the predefined first activity which is “booking the flight tickets”. If the pre-recorded activities are unavailable, the activity automation system 105 disregards the second activity.

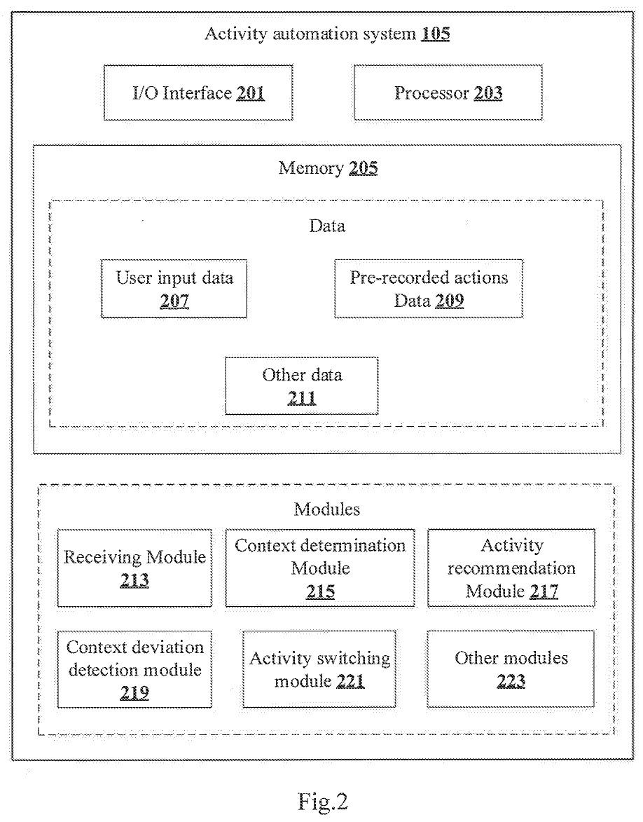

FIG. 2 shows block diagram of an activity automation system 105 in accordance with some embodiments of the present disclosure. The activity automation system 105 may include an I/O interface 201, a processor 203, and a memory 205. The I/O interface 201 may be configured to receive the user inputs 104 and to provide a response for the user inputs 104. The memory 205 may be communicatively coupled to the processor 203. The processor 203 may be configured to perform one or more functions of the activity automation system 105.

In some implementations, the activity automation system 105 may include data and modules for performing various operations in accordance with embodiments of the present disclosure. In an embodiment, the data may be stored within the memory 205 and may include, without limiting to, user input data 207, pre-recorded actions data 209 and other data 211. In some embodiments, the data may be stored within the memory 205 in the form of various data structures. Additionally, the data may be organized using data models, such as relational or hierarchical data models. The other data 211 may store data, including temporary data and temporary files, generated by the modules for performing various functions of the activity automation system 105. In an embodiment, one or more modules may process the data of the activity automation system 105. In one implementation, the one or more modules may be communicatively coupled to the processor 203 for performing one or more functions of the activity automation system 105. The modules may include, without limiting to, a receiving module 213, a context determination module 215, an activity recommendation module 217, a context deviation detection module 219, an activity switching module 221 and other modules 223.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. In an embodiment, the other modules 223 may be used to perform various miscellaneous functionalities of the activity automation system 105. It will be appreciated that such modules may be represented as a single module or a combination of different modules. Furthermore, a person of ordinary skill in the art will appreciate that in an implementation, the one or more modules may be stored in the memory 205, without limiting the scope of the disclosure. The said modules when configured with the functionality defined in the present disclosure will result in a novel hardware.

In an embodiment, the receiving module 213 may be configured to receive user inputs 104 from the one or more users 103 in one or more input modes. The received user inputs 104 is stored in the database 107 as the user input data 207. The one or more input modes may include at least one of voice, text, video and gesture. In an embodiment, during training phase of the activity automation system 105, each of the input modes used by the one or more users 103 is assigned with a predefined score. As an example, for user 1, the input mode “voice” may be assigned with a predefined score of 10. The input mode “text” may be assigned with a predefined score 30, the input mode “video” may be assigned with a predefined score 20 and the input mode “gesture” may be assigned with a predefined score “40”.

Similarly, for user 2, the input mode “voice” may be assigned with a predefined score of 20. The input mode “text” may be assigned with a predefined score 10, the input mode “video” may be assigned with a predefined score 40 and the input mode “gesture” may be assigned with a predefined score “30”. Further, during the training phase, the one or more activities of each of the one or more users is stored in the database 107 as the pre-recorded activities. For example, the pre-recorded activities for user 1 may be “booking flight” first and then “booking a cab”. Similarly, the prerecorded activities for user 2 may be “setting an appointment with a client” first and then “booking a cab”. The set of activities and the order of the activities are stored in the database 107. For each pre-recorded activity of each of the one or more users 103, the step-by-step process of performing the pre-recorded activity is also stored in the database 107 as the pre-recorded actions data 209.

In an embodiment, the context determination module 215 may be configured to determine the context of the user input. The context determination module 215 determines the context based on the predefined score associated with each of the one or more input modes. As an example, user 2 may provide user inputs 104 to the activity automation system 105 using the input modes such as voice and video. The predefined score associated with each of these input modes are 20 and 40 respectively. The context determination module 215 aggregates the user inputs received from each of these input modes to determine correct context from the user input 104. As an example, the user 2 may provide a voice input for searching for hotels in a specific locality. After looking at the list of hotels suggested by the activity automation system 105 which are below 3-star, the user may show facial expressions of “sad” and after looking at 5-star hotels may show facial expressions of being “happy”. The activity automation system 105 records these facial expressions via video and aggregates these inputs and determines that the user is willing to see 5-star hotels and not 3-star hotels. Therefore, the activity automation system 105 provides information of only 5-star hotels afterwards. Hence, the activity automation system 105 infers the correct context from the user input which is “looking for 5-star hotels”. The activity automation system 105 aggregates these inputs to infer the correct context. Since the predefined score assigned to “video” input is more than the predefined score assigned to the “voice” input, the activity automation system 105 may provide high importance for the user input received through the “video” input mode. The activity automation system 105 infers the correct context based on the user inputs 104 using one or more natural language processing techniques.

In an embodiment, the activity recommendation module 217 may be configured to recommend the activity based on the context determined and one or more pre-recorded activities of the one or more users. As an example, for user 1, the pre-recorded activities are “booking the flight” and “booking the cab”. Based on the user input received from user 1, through the one or more input modes the activity recommendation module 217 recommends the predefined first activity for the user 1 which is “booking flight tickets”. In some embodiment, the activity recommendation module 217 may also be configured to recommend the predefined activity for the group of users.

In some exemplary embodiment, there may be group of users working towards a common objective. Since there is a common objective, the predefined activity suggested for the group of users may be automated. As an example, a particular department of an Information Technology (IT) organization may be working for resolving tickets raised by users. The tickets may be related to policy related queries, software installation queries or any other queries related to IT and Human Resource (HR) policies. As an example, the query raised by a user may be “How to configure a mail account”. The group of people in the department may perform similar functions to resolve the query. In such scenario, the activity automation system 105 receives user input from each of the one or more users of the group working towards resolving the query in one or more input modes. Thereafter, the activity automation system 105 identifies a common context based on the user input from each of the one or more users which in this scenario is open the outlook page->go to file->go to info->go to account settings->go to account setting->go to new->enter your email id->finishthese activities would be recommended as a predefined first activity for each of the one or more users and which would later be automated.

In an embodiment, the context deviation detection module 219 may be configured to detect a deviation from the context associated with the predefined first activity. As an example, the predefined first activity for user-1 is “booking flight tickets”. As per the pre-recorded activities of user 1, the user 1 may perform the activity of “booking the cab” after performing the predefined first activity which is “booking flight tickets”. Hence, the activity automation system 105 suggests the user 1 to perform the activity of “cab booking”. However, while performing the predefined first activity “booking flight tickets”, the user may involve in a conversation. Based on user inputs 104 during the conversation the activity automation system 105 detects that the user wishes to book a movie ticket. The activity automation system 105 detects the change in the context associated with a second activity i.e. change from the predefined activity of “booking flight tickets” to the second activity of “booking a movie ticket”. Once the change in the context is detected, the activity automation system 105 detects whether there is availability of pre-recorded activities related to the second activity in the database 107. If the pre-recorded activities are available in the database 107, the activity automation system 105 performs the second activity. If the pre-recorded activities are unavailable in the database 107, the activity automation system 105 disregards the second activity. In some embodiments, the pre-recorded activities may be disregarded upon detecting less frequency of the pre-recorded activities. However, the pre-recorded activities may be recorded/updated for future use by the activity automation system 105.

In an embodiment, the activity switching module 221 may be configured to switch between the activities. Once the second activity is performed, the activity automation system 105 switches back to the predefined first activity to complete the predefined first activity.

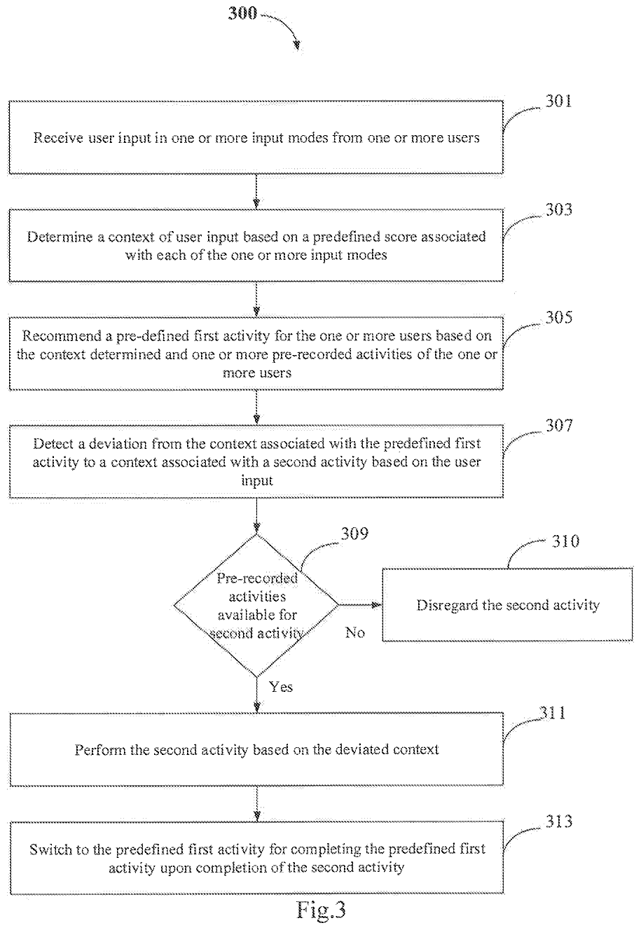

FIG. 3 shows a flowchart illustrating a method of automating context-based switching between user activities in accordance with some embodiments of the present disclosure. As illustrated in FIG. 3, the method 300 includes one or more blocks illustrating a method of automating context-based switching between user activities. The method 300 may be described in the general context of computer executable instructions. Generally, computer executable instructions can include routines, programs, objects, components, data structures, procedures, modules, and functions, which perform specific functions or implement specific abstract data types. The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, the method includes receiving user input in one or more input modes. The one or more input modes comprises at least one of voice, text, video and gesture. The user may provide the user input to the activity automation system 105 to initiate any activity or the process. At block 303, the method includes determining a context of the user input based on a predefined score associated with each of the one or more input modes. In an embodiment, the predefined score is assigned to each input mode used by each of the one or more users during training phase of the activity automation system 105. At block 305, the method includes recommending a predefined first activity for the one or more users based on the context determined and one or more pre-recorded activities of the one or more users stored in a database 107 associated with the activity automation system 105. As an example, the predefined first activity for user 1 may be “booking flight ticket”. The predefined first activity for user 2 may be “booking a cab” and the predefined first activity for the user 3 may be “scheduling an appointment with client”. At block 307, the method includes, detecting a deviation from the context associated with the predefined first activity to a context associated with a second activity, based on the user input. While the predefined first activity is being performed, the activity automation system 105 may detect change in the context for example, from “booking a flight ticket” to “booking a movie ticket” based on input received from the user. Upon detecting the deviation from the context associated with the first predefined activity i.e. “booking flight ticket” to the context associated with the second activity i.e. “booking a movie ticket”, the activity automation system 105 detects availability of pre-recorded activities related to the second activity in the database 107 at block 309. If the pre-recorded activities are available in the database 107, the activity automation system 105 proceeds to block 311 and performs the second activity. If the pre-recorded activities are unavailable in the database 107, the activity automation system 105 proceeds to block 310 and disregards the second activity. At block 313, the method includes, switching to the predefined first activity, for completing the predefined first activity, upon completion of the second activity.

### Computer System

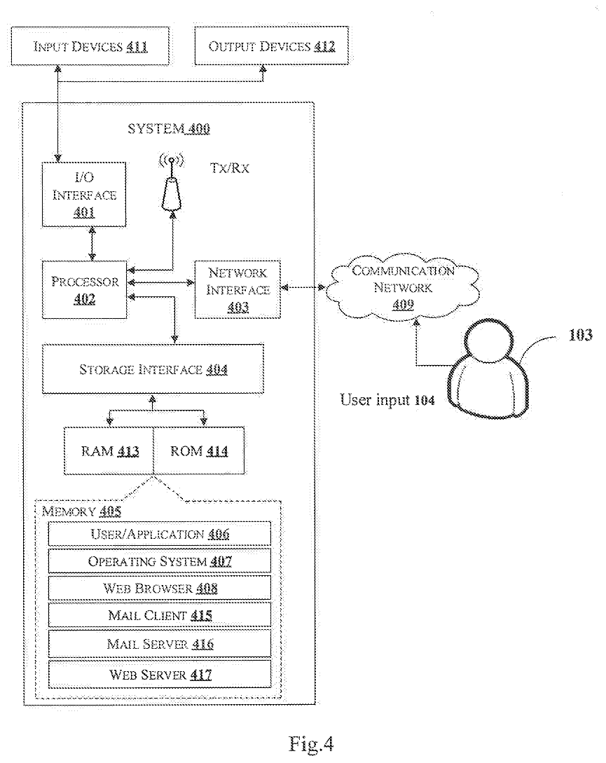

FIG. 4 illustrates a block diagram of an exemplary computer system 400 for implementing embodiments consistent with the present disclosure. In an embodiment, the computer system 400 may be activity automation system 105, which is used for automating context-based switching between user activities. The computer system 400 may include a central processing unit (“CPU” or “processor”) 402. The processor 402 may comprise at least one data processor for executing program components for executing user 103 or system-generated business processes. A user 103 may include a person, a user 103 in the computing environment 100, a user 103 querying the activity automation system 105, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via 1/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 401, the computer system 400 may communicate with one or more I/O devices 411 and 412. In some implementations, the I/O interface 401 may be used to connect to a user device, such as a smartphone, a laptop, or a desktop computer associated with the user 103, through which the user 103 interacts with the activity automation system 105.

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with the user 103 to receive the query and to provide the one or more responses.

The communication network 409 can be implemented as one of the several types of networks, such as intranet or Local Area Network (LAN) and such within the organization. The communication network 409 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application 406, an operating system 407, a web browser 408, mail client 415, mail server 416, web server 417 and the like. In some embodiments, computer system 400 may store user/application data 406, such as the data, variables, records, etc. as described in this invention. Such databases may be implemented as fault-tolerant, relational, scalable, secure databases such as Oracle® or Sybase®.

The operating system 407 may facilitate resource management and operation of the computer system 400. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like. A user 103 interface may facilitate display, execution, interaction, manipulation, or operation of program components through textual or graphical facilities. For example, user 103 interfaces may provide computer interaction interface elements on a display system operatively connected to the computer system 400, such as cursors, icons, check boxes, menus, windows, widgets, etc. Graphical User 103 Interfaces (GUIs) may be employed, including, without limitation, APPLE MACINTOSH® operating systems, IBM™ OS/2, MICROSOFT™ WINDOWS™ (XP™, VISTA™/7/8, 10 etc.), Unix® X-Windows, web interface libraries (e.g., AJAX™, DHTML™, ADOBE® FLASH™, JAVASCRIPT™, JAVA™, etc.), or the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein

In an embodiment, the present disclosure provides a method and system for automating context-based switching between user activities. In an embodiment, the method of present disclosure enables the user to provide inputs using different input modes and the method predicts correct context from the user input by collating all the input modes. In an embodiment, the present disclosure enables the user to switch between different contexts and resume back to the activities which were left incomplete. In an embodiment, the present disclosure enables the user to automate various activities as per comfort and requirements of the user which are detected correctly using user inputs. In an embodiment, the present disclosure enables the user to perform different activities seamlessly by identifying the context though the user switch between the activities. The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all the items are mutually exclusive, unless expressly specified otherwise. The terms “a”, “an” and “the” mean “one or more”, unless expressly specified otherwise. A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference Number | Description |
|---|---|
| 100 | Environment |
| 103 | Users |
| 104 | User inputs |
| 105 | Activity Automation System |
| 107 | Database |
| 201 | I/O Interface |
| 203 | Processor |
| 205 | Memory |
| 207 | User input data |
| 209 | Pre-recorded actions data |
| 211 | Other data |
| 213 | Receiving Module |
| 215 | Context determination Module |
| 217 | Activity recommendation Module |
| 219 | Context deviation detection module |
| 221 | Activity switching Module |
| 223 | Other Modules |
| 400 | Exemplary computer system |
| 401 | I/O Interface of the exemplary computer system |
| 402 | Processor of the exemplary computer system |
| 403 | Network interface |
| 404 | Storage interface |
| 405 | Memory of the exemplary computer system |
| 406 | User/Application |
| 407 | Operating system |
| 408 | Web browser |
| 409 | Communication network |
| 411 | Input devices |
| 412 | Output devices |
| 413 | RAM |
| 414 | ROM |
| 415 | Mail Client |
| 416 | Mail Server |
| 417 | Web Server |

We claim:

1. A method of automating context-based switching between user activities, the method comprising:
receiving, by an activity automation system 105, user input 104 in one or more input modes from one or more users 103;
determining, by the activity automation system 105, a context of the user input 104 based on a predefined score associated with each of the one or more input modes;
recommending, by the activity automation system 105, a pre-defined first activity for the one or more users based on the context determined and one or more pre-recorded activities of the one or more users stored in a database 107 associated with the activity automation system 105;
detecting, by the activity automation system 105, a deviation from the context associated with the predefined first activity to a context associated with a second activity, based on the user input 104;
performing, by the activity automation system, the second activity based on the deviated context upon detecting availability of pre-recorded activities related to the second activity in the database 107; and
switching, by the activity automation system 105, to the predefined first activity, for completing the predefined first activity, upon completion of the second activity.

2. The method as claimed in claim 1, wherein the one or more input modes comprises at least of voice, text, video and gesture.

3. The method as claimed in claim 1, wherein the predefined score is assigned to each of the one or more input modes during training phase of the activity automation system 105.

4. The method as claimed in claim 1, wherein the pre-recorded activities corresponding to the one or more users 103 is stored in the database 107.

5. The method as claimed in claim 1 further comprises disregarding the second activity upon detecting unavailability of the pre-recorded activities related to the second activity in the database 107.

6. The method as claimed in claim 1 further comprises:
receiving user input 104 from each of the one or more users 103 in one or more input modes;
identifying a first activity for each of the one or more users based on context of the corresponding user input 104;
identifying a common context for the first activity of each of the one or more users 103; and
recommending the first activity associated with the common context as the pre-defined first activity for each of the one or more users 103.

7. An activity automation system 105 for automating context-based switching between user activities, the activity automation system 105 comprising:
a processor 203; and
a memory 205 communicatively coupled to the processor 203, wherein the memory 205 stores the processor-executable instructions, which, on execution, causes the processor to:
receive user input 104 in one or more input modes from one or more users 103;
determine a context of the user input 104 based on a predefined score associated with each of the one or more input modes;
recommend a pre-defined first activity for the one or more users based on the deviated context determined and one or more pre-recorded activities of the one or more users stored in a database 107 associated with the activity automation system 105;
detect a deviation from the context associated with the pre-defined first activity to a context associated with a second activity, based on the user input 104;
(i) perform the second activity based on the changed context upon detecting availability of pre-recorded activities related to the second activity in the database 107; and
(ii) switch to the pre-defined first activity for completing the pre-defined first activity upon completion of the second activity.

8. The system 105 as claimed in claim 7, wherein the one or more input modes comprises at least one of voice, text, video and gesture.

9. The system 105 as claimed in claim 7, wherein the processor assigns the predefined score to each of the one or more input modes during training phase of the activity automation system.

10. The system 105 as claimed in claim 7, wherein the processor 203 stores pre-recorded activities corresponding to of the one or more users in the database.

11. The system 105 as claimed in claim 7, wherein the processor 203 disregards the second activity upon detecting unavailability of the pre-recorded activities related to the second activity in the database.

12. The system 105 as claimed in claim 7, wherein the processor 203 is further configured to:
receive user input 104 from each of the one or more users 103 in one or more input modes;
identify a first activity for each of the one or more users 103 based on context of the corresponding user input 104;
identify a common context for the first activity of each of the one or more users 103; and
recommend the first activity associated with the common context first activity as the pre-defined first activity for each of the one or more users 103.
